(19) United States
(12) Patent Application Publication
(10) Pub. No.: US 2025/0353451 A1
(43) Pub. Date: Nov. 20, 2025

(54) Snap-On Trim Member Overlay with Surround and Method for Manufacturing the Same

(71) Applicant: Neo Design, LLC, Bowie, MD (US)

(72) Inventor: Naje Fattouche, Bowie, MD (US)

(73) Assignee: Neo Design, LLC, Bowie, MD (US)

(21) Appl. No.: 19/190,928

(22) Filed: Apr. 28, 2025

Related U.S. Application Data
(60) Provisional application No. 63/648,275, filed on May 16, 2024.

(51) Int. Cl. B60R 13/04

(52) U.S. Cl. CPC B60R 13/04

(57) ABSTRACT

A snap-on trim accent member overlay for covering and surrounding an existing trim accent piece of a vehicle includes an elongate panel, an extended surround, and a plurality of clasp mechanisms. The elongate panel has an elongate panel perimeter defining an elongate panel top surface and an elongate panel bottom surface. The extended surround is attached to and extends from the elongate panel perimeter. Each clasp mechanism of the plurality of clasp mechanisms includes a lip member attached to and extending from the elongate panel bottom surface. The lip member has a lip member inner surface with an angle formed between the elongate panel bottom surface and the lip member inner surface being in a range of between 15° and 60°.

### CROSS REFERENCES AND PRIORITIES

This Application claims priority from U.S. Provisional Application No. 63/648,275 filed on 16 May 2024, the teachings of which are incorporated by reference herein in their entirety.

### BACKGROUND

Aftermarket components are typically used to enhance automobile cosmetics and/or repair or replace damaged original automotive equipment. Such components can include trim accents such as tailgate trim members, door moldings, window-sill moldings, and side mirror covers which fit over the manufacturer's (or another aftermarket) installed trim accents and provide a customized appearance.

Trim accents are typically custom manufactured to precisely fit with a specific make and model of vehicle. Commonly, aftermarket trim accent members are finished in a chrome, black, or other colored finish, thus providing a new look to the automobile upon which the trim accent member is installed.

Many trim accent members utilize clips and/or adhesives that are difficult to precisely and securely install, and are prone to failures leading to the trim accent member separating from the vehicle. Further, many trim accent members fail to encompass the edges of the vehicle trim component to which they attach thereby creating an unappealing aesthetic.

The need exists, therefore, for an improved trim accent member overlay with a surround portion which encompasses the edges of an existing vehicle trim component and that is simple to securely install to the vehicle, reducing and eliminating breakage during installation and vehicle operation, and adhering firmly to the vehicle so as not to separate during vehicle operation.

### SUMMARY

Described herein is a trim accent member overlay for covering and surrounding an existing vehicle trim accent piece of a vehicle. The trim accent member overlay includes an elongate panel, an extended surround, and a plurality of clasp mechanisms. The elongate panel having an elongate panel perimeter defining an elongate panel top surface and an elongate panel bottom surface opposite the elongate panel top surface. The extended surround attaches to and extends from the elongate panel perimeter. The plurality of clasp mechanisms attach to and extend from the elongate panel bottom surface. Each clasp mechanism of the plurality of clasp mechanisms has a lip member having a lip member inner surface with the lip member being attached to and extending from the elongate panel bottom surface. Each clasp mechanism of the plurality of clasp mechanisms is attached to the elongate panel bottom surface. A first angle formed between the elongate panel bottom surface and the lip member inner surface of each clasp mechanism of the plurality of clasp mechanisms is in a range of between 15° and 60°.

In some embodiments, at least one clasp mechanism of the plurality of clasp mechanisms may include a base member having a base member perimeter defining a base member top surface and a base member bottom surface opposite the base member top surface. The base member bottom surface may be attached to the elongate panel bottom surface. A second angle formed between the base member top surface and the lip member inner surface of each clasp mechanism of the plurality of clasp mechanisms may be in a range of between 15° and 60°.

In certain embodiments, each clasp mechanism of the plurality of clasp mechanisms may include a base member having a base member perimeter defining a base member top surface and a base member bottom surface opposite the base member top surface. The base member bottom surface may be attached to the elongate panel bottom surface. A second angle formed between the base member top surface and the lip member inner surface of each clasp mechanism of the plurality of clasp mechanisms may be in a range of between 15° and 60°.

In some embodiments, each clasp mechanism of the plurality of clasp mechanisms may be located at a separate location about the elongate panel perimeter.

In certain embodiments, the trim accent member overlay may further include at least one adhesive member attached to the elongate panel bottom surface.

In some embodiments, the elongate panel may comprise a material selected from the group consisting of acrylonitrile butadiene styrene (ABS), polyethylene (PE), and nylon.

In certain embodiments, the extended surround may be configured to cover the existing vehicle trim accent piece such that less than 5% of a total surface area of the existing trim accent piece is visible when the trim accent member overlay is attached to the existing vehicle trim accent piece.

In some embodiments, the trim accent member overlay may further include at least one secondary elongate panel and a plurality of secondary clasp mechanisms. The at least one secondary elongate panel—when present—has a secondary elongate panel perimeter defining a secondary elongate panel top surface and a secondary elongate panel bottom surface opposite the secondary elongate panel top surface. When present, the plurality of secondary clasp mechanisms attach to and extend from the secondary elongate panel bottom surface. Each secondary clasp mechanism of the plurality of secondary clasp mechanisms having a secondary lip member having a secondary lip member inner surface. The secondary lip member being attached to and extending from the secondary elongate panel bottom surface. Each secondary clasp mechanism of the plurality of secondary clasp mechanisms attaches to the secondary elongate panel bottom surface. A third angle formed between the secondary elongate panel bottom surface and the secondary lip member inner surface of each secondary clasp mechanism of the plurality of secondary clasp mechanisms is in a range of between 15° and 60°.

In some embodiments comprising a secondary elongate panel and a plurality of secondary clasp mechanisms, at least one secondary clasp mechanism of the plurality of secondary clasp mechanisms may include a secondary base member. The secondary base member having a secondary base member perimeter defining a secondary base member top surface and a secondary base member bottom surface opposite the secondary base member top surface. The secondary base member bottom surface attaches to the secondary elongate panel bottom surface. A fourth angle formed between the secondary base member top surface and the secondary lip member inner surface of each secondary clasp mechanism of the plurality of secondary clasp mechanisms being in a range of between 15° and 60°.

In certain embodiments comprising a secondary elongate panel and a plurality of secondary clasp mechanisms, each secondary clasp mechanism of the plurality of secondary clasp mechanisms may include a secondary base member. The secondary base member having a secondary base member perimeter defining a secondary base member top surface and a secondary base member bottom surface opposite the secondary base member top surface. The secondary base member bottom surface attaches to the secondary elongate panel bottom surface. A fourth angle formed between the secondary base member top surface and the secondary lip member inner surface of each secondary clasp mechanism of the plurality of secondary clasp mechanisms being in a range of between 15° and 60°.

In some embodiments comprising a secondary elongate panel and a plurality of secondary clasp mechanisms, each secondary clasp mechanism of the plurality of secondary clasp mechanisms may be located at a separate location about the secondary elongate panel perimeter.

In certain embodiments comprising a secondary elongate panel and a plurality of secondary clasp mechanisms, the trim accent member overlay may further include at least one secondary adhesive member attached to the secondary elongate panel bottom surface.

In some embodiments comprising a secondary elongate panel and a plurality of secondary clasp mechanisms, the secondary elongate panel may comprise a material selected from the group consisting of acrylonitrile butadiene styrene (ABS), polyethylene (PE), and nylon.

In certain embodiments comprising a secondary elongate panel and a plurality of secondary clasp mechanisms, the trim accent member overlay may further include a secondary extended surround attached to and extending from the secondary elongate panel perimeter. When the secondary extended surround is present, it may be configured to cover a secondary existing vehicle trim accent piece such that less than 5% of a total surface area of the secondary existing trim accent piece is visible when the secondary elongate panel is attached to the secondary existing vehicle trim accent piece.

In some embodiments, the trim accent member overlay may be in the form of a door molding. The door molding may be configured to attach to an existing door molding of the vehicle by engaging the plurality of clasp mechanisms and optionally the plurality of secondary clasp mechanisms to the existing door molding.

In certain embodiments, the trim accent member overlay may be in the form of a tailgate trim member. The tailgate trim member may be configured to attach to an existing tailgate trim member of the vehicle by engaging the plurality of clasp mechanisms and optionally the plurality of secondary clasp mechanisms to the existing tailgate trim member.

In some embodiments, the trim accent member overlay may be in the form of a window-sill molding. The window-sill molding may be configured to attach to an existing window sill of the vehicle by engaging the plurality of clasp mechanisms and optionally the plurality of secondary clasp mechanisms to the existing window sill.

In certain embodiments, the trim accent member overlay may be in the form of a side mirror cover. The side mirror cover may be configured to attach to an existing side mirror of the vehicle by engaging the plurality of clasp mechanisms and optionally the plurality of secondary clasp mechanisms to the existing side mirror.

Also described herein is a process for manufacturing a trim accent member overlay for covering and surrounding an existing vehicle trim accent piece of a vehicle. The trim accent member overlay including an elongate panel and a plurality of clasp mechanisms. The elongate panel having an elongate panel perimeter defining an elongate panel top surface and an elongate panel bottom surface opposite the elongate panel top surface. The plurality of clasp mechanisms attaching to and extending from the elongate panel bottom surface. Each clasp mechanism of the plurality of clasp mechanisms having a lip member having a lip member inner surface. The lip member attaching to and extending from the elongate panel bottom surface. Each clasp mechanism of the plurality of clasp mechanisms attaching to the elongate panel bottom surface. A first angle formed between the elongate panel bottom surface and the lip member inner surface of each clasp mechanism of the plurality of clasp mechanisms being in a range of between 15° and 60°.

The process for manufacturing the trim accent member includes providing a mold having a mold cavity in the form of the trim accent panel member overlay. Injecting a molten material selected from the group consisting of acrylonitrile butadiene styrene (ABS), polyethylene (PE), and nylon into the mold cavity. Allowing the molten material to cool and cure, and removing the trim accent member overlay from the mold cavity.

### BRIEF DESCRIPTION OF FIGURES

FIG. 1 is a perspective view of a trim accent member overlay with a surround portion for a vehicle.

FIG. 2 is a bottom view of a trim accent member overlay with a surround portion for a vehicle.

FIG. 3A is an end view of a trim accent member overlay with a surround portion for a vehicle.

FIG. 3B is an end view of an alternative trim accent member overlay with a surround portion for a vehicle.

FIG. 4 is a side view of a clasp mechanism.

FIG. 5 is an exploded view of a vehicle having an existing tailgate trim member with a trim accent member overlay with a surround portion that is a tailgate trim member.

FIG. 6 is an assembled view of the vehicle of FIG. 5 with the tailgate trim member overlay attached to the existing tailgate trim member.

FIG. 7 is a partial cut-away view of a tailgate trim member overlay attached to an existing tailgate trim member of a vehicle.

FIG. 8 is a perspective view of a trim accent member overlay with a surround portion for a vehicle.

FIG. 9 is a bottom view of a trim accent member overlay with a surround portion for a vehicle.

FIG. 10 is an end view of a trim accent member overlay with a surround portion for a vehicle.

FIG. 11 is an exploded view of a vehicle having an existing door molding with a trim accent member overlay with a surround portion that is a door molding.

FIG. 12 is an assembled view of the vehicle of FIG. 11 with the door molding overlay attached to the existing door molding.

FIG. 13 is a partial cut-away view of a door molding overlay attached to an existing door molding of a vehicle.

FIG. 14 is an exploded view of a vehicle having a window-sill with a trim accent member overlay with a surround portion that is a window sill molding.

FIG. 15 is an assembled view of the vehicle of FIG. 14 with the window-sill molding overlay attached to the window sill.

FIG. 16 is a partial cut-away view of a window-sill molding overlay attached to a window sill of a vehicle.

FIG. 17 is an exploded view of a vehicle having a side mirror with a trim accent member overlay with a surround portion that is a side mirror cover.

FIG. 18 is an assembled view of the vehicle of FIG. 17 with the side mirror cover overlay attached to the side mirror.

FIG. 19 is a partial cut-away view of a side mirror cover overlay attached to a side mirror of a vehicle.

FIG. 20 is an exploded view of a vehicle having a side mirror with a trim accent member overlay with a surround portion that is a side mirror cover.

FIG. 21 is an assembled view of the vehicle of FIG. 20 with the side mirror cover overlay attached to the side mirror.

FIG. 22 is a partial cut-away view of a side mirror cover overlay attached to a side mirror of a vehicle.

### DETAILED DESCRIPTION

Disclosed herein is a snap-on trim accent member overlay for a vehicle. As described herein, the following numbers refer to the following structures as noted in the Figures.
10 refers to a vehicle.
11 refers to an existing door molding.
12 refers to an existing tailgate trim member.
13 refers to an existing window-sill.
14 refers to an existing side mirror.
15 refers to an existing manufacturer's badge.
100 refers to a trim accent member overlay.
110 refers to a door molding.
120 refers to a tailgate trim member.
130 refers to a window-sill molding.
140 refers to a side mirror cover.
200 refers to an elongate panel.
210 refers to an elongate panel top surface.
220 refers to an elongate panel bottom surface.
230 refers to an extended surround.
235 refers to a lip.
300 refers to a clasp mechanism.
310 refers to a lip member.
311 refers to a lip member inner surface.
320 refers to a base member.
321 refers to a base member top surface.
322 refers to a base member bottom surface.
400 refers to an adhesive member.
500 refers to a secondary elongate panel.
510 refers to a secondary elongate panel top surface.
520 refers to a secondary elongate panel bottom surface.
530 refers to a secondary elongate panel extended surround.
535 refers to a secondary lip.
600 refers to a secondary clasp mechanism.
610 refers to a secondary lip member.
611 refers to a secondary lip member inner surface.
620 refers to a secondary base member.
621 refers to a secondary base member top surface.
622 refers to a secondary base member bottom surface.
700 refers to a secondary adhesive member.
800 refers to a hook member.
α₁ refers to a first angle (formed between the elongate panel bottom surface and the lip member inner surface).
α₂ refers to a second angle (formed between the base member top surface and the lip member inner surface).
α₃ refers to a third angle (formed between the secondary elongate panel bottom surface and the secondary lip member inner surface).
α₄ refers to a fourth angle (formed between the secondary base member top surface and the secondary lip member inner surface).

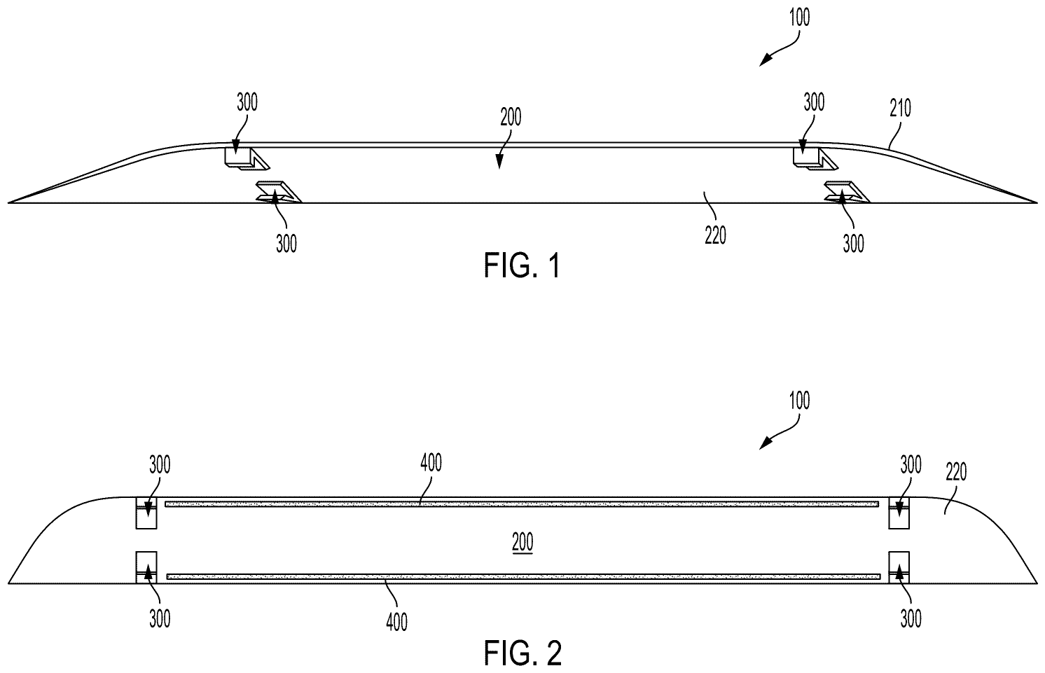

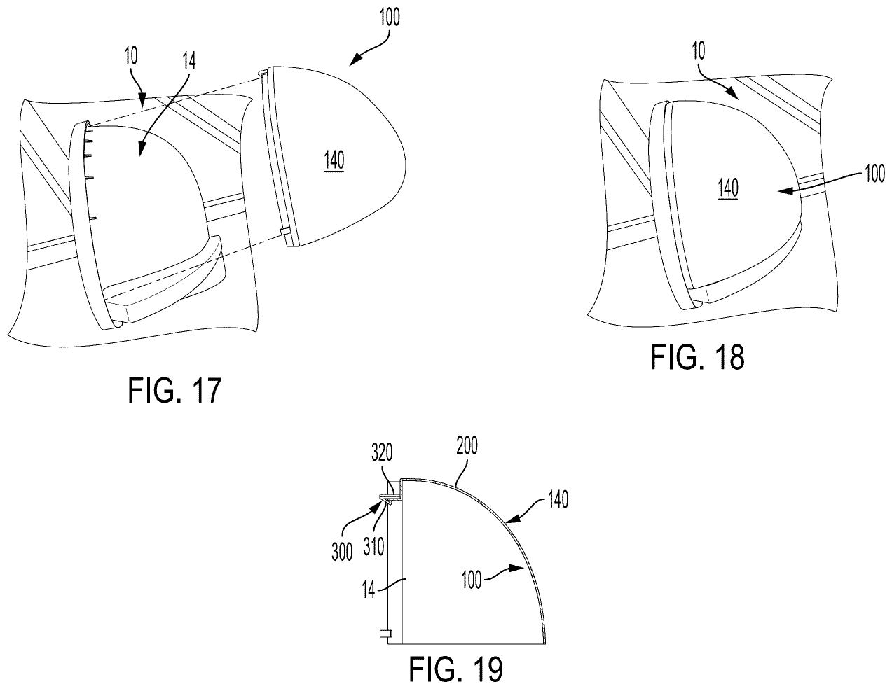

FIG. 1 illustrates an embodiment of a snap-on trim accent member overlay (100) with surround for a vehicle ((10), an example of which is shown in FIG. 6) in perspective view. The trim accent member overlay may take many forms including, but not limited to, a door molding ((110), an example of which is shown in FIG. 8 to FIG. 13), a tailgate trim member ((120), an example of which is shown in FIG. 1 to FIG. 7), a window sill molding ((130), an example of which is shown in FIG. 14 to FIG. 16), a side mirror cover ((140), examples of which are shown in FIG. 17 to FIG. 20), and a badge.

As shown in FIG. 1, the trim accent member overlay (100) includes an elongate panel (200) and a plurality of clasp mechanisms (300) which allow the trim accent member overlay to “snap on” to an existing vehicle trim member. The elongate panel has an elongate panel perimeter which defines an elongate panel top surface (210) and an elongate panel bottom surface ((220) as shown in FIG. 2 which is a bottom view of the trim accent member overlay) opposite the elongate panel top surface. The elongate panel perimeter preferably includes an extended surround (230) which extends beyond the perimeter of an existing vehicle trim accent piece which the elongate panel is configured to attach to such that—once attached—the trim accent member overlay surrounds the entirety of the outer periphery of the existing vehicle trim accent piece. Preferably, no space is left between the outer periphery of the existing vehicle trim accent piece and the elongate panel perimeter. However, in some embodiments, a small amount of space—preferably less than 2.5 mm in width, with less than 1.0 mm in width being more preferred, and less than 0.5 mm in width being still more preferred—may be left between the outer periphery of the existing vehicle trim accent piece and the elongate panel perimeter when the trim accent member overlay is attached to the existing vehicle trim accent piece. In some embodiments, the extended surround may include a lip (235) on the elongate panel perimeter which wraps around the peripheral edge of the existing vehicle trim accent piece.

The elongate panel perimeter may come in a variety of different shapes and sizes, some of which are illustrated in the figures, depending upon the intended use of the trim accent member overlay. Nonlimiting examples of such shapes include a substantially square shape, a substantially rectangular shape, a substantially trapezoidal shape, a substantially parallelogram shape, a substantially triangular shape, a substantially ovular shape, and the like.

FIG. 2 illustrates a bottom view of an embodiment of a trim accent member overlay (100). As shown in FIG. 2, each clasp mechanism (300) of the plurality of clasp mechanisms may be located at a separate location about the elongate panel perimeter.

These clasp mechanisms allow the trim accent member overlay to attach to a vehicle ((10), an example of which is shown in FIG. 6) about a vehicle surface such as an existing trim accent piece.

FIG. 2 also shows an optional adhesive member (400). When present, the adhesive member may be attached to the elongate panel bottom surface (220) and may serve to assist—in conjunction with the clasp mechanisms—in securing the elongate panel to a vehicle surface. Nonlimiting examples of adhesives which may be utilized include double sided tape, glue, epoxy, and the like.

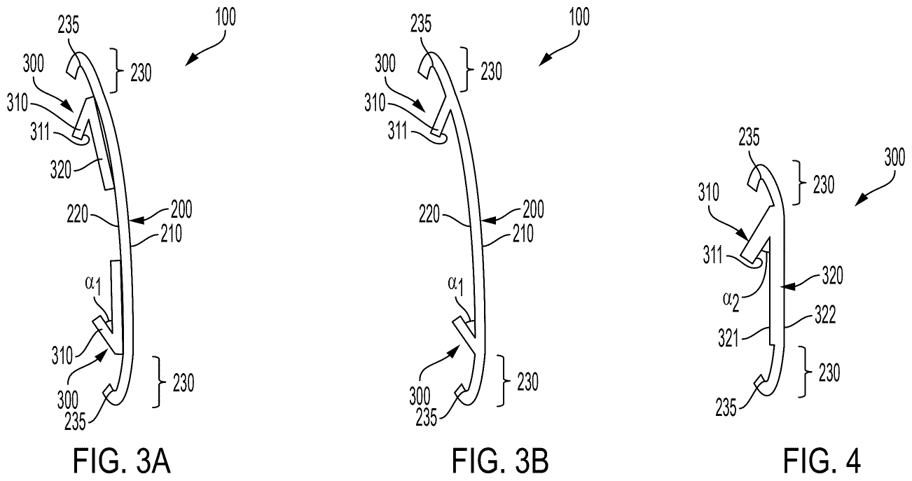

FIG. 3A and FIG. 3B illustrate end views of embodiments of a trim accent member overlay (100) including additional details of a clasp mechanism (300). As shown in FIG. 3A and FIG. 3B, each clasp mechanism of the plurality of clasp mechanisms is attached to and extends from the elongate panel bottom surface (220). Each clasp mechanism of the plurality of clasp mechanisms includes a lip member (310) and—optionally—a base member ((320) as shown in FIG. 3A). The base member is considered optional as certain embodiments (such as shown in FIG. 3B) may exist in which the lip member is integrally connected to the elongate panel bottom surface such as by injection molding the elongate panel and the clasp mechanism of a single unitary piece of material. In such embodiments, the elongate panel may be thought of as both the elongate panel and the base member of the clasp mechanism.

While the Figures illustrate examples of individual, narrow clasp mechanisms (300) which are arranged at different positions on the elongate panel bottom surface (220), other embodiments may exist. In some embodiments, one or more peripheral edges of the elongate panel may include a clasp mechanism which extends all or a portion of the length of said peripheral edge. Certain embodiments may also exist in which each peripheral edge of the elongate panel includes a clasp mechanism which spans the entire length of said peripheral edges.

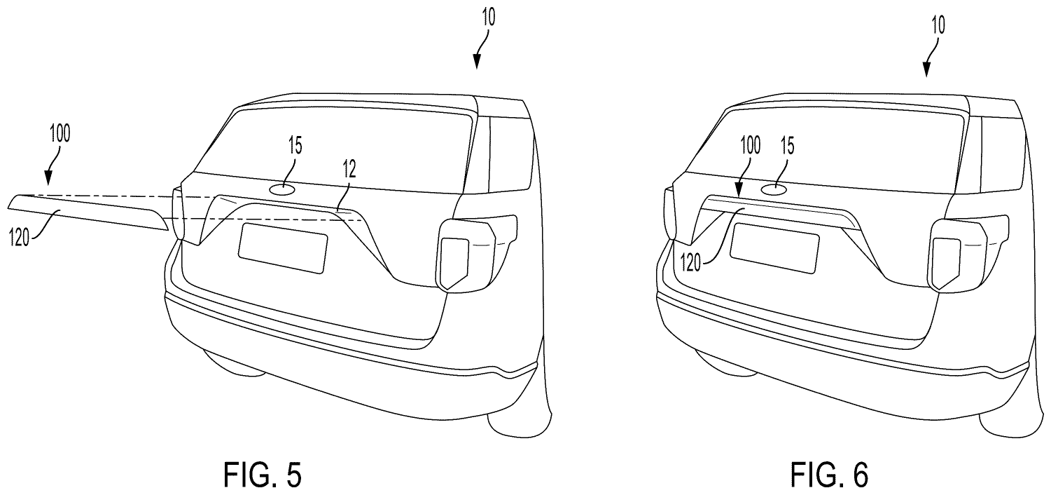

FIG. 4 illustrates a side view of further details of the clasp mechanism (300). The lip member (310) is attached to and extends from the elongate panel bottom surface (220). In doing so, a first angle (α₁) is formed between the elongate panel bottom surface and a lip member inner surface (321) as shown in FIG. 3. This angle will preferably be in a range selected from the group consisting of between 15° and 60°, between 15° and 45°, between 15° and 30°, between 30° and 60°, between 30° and 45°, and between 45° and 60°. In embodiments where the elongate panel bottom surface is substantially planar, the first angle is measured between the lip member inner surface and the elongate panel bottom surface. However, embodiments may exist in which the elongate panel bottom surface is concave, convex, or otherwise includes a non-planar surface. In such instances, the first angle is measured between the lip member inner surface and a plane aligned with a central axis of the non-planar surface.

While FIG. 4 illustrates a clasp mechanism (300) which is angular, other embodiments may exist. For example, in certain embodiments, one or more of the clasp mechanisms may have a curved or hooked shape with a concave lip member inner surface (321).

FIG. 4 also shows the—optional—base member (320). As shown in FIG. 4, when the base member is present, the base member includes a base member perimeter defining a base member top surface (321) and a base member bottom surface (322) opposite the base member top surface. In such cases, the lip member (310) is attached to and extends from the base member top surface (321). In doing so, a second angle (α_{z}) is formed between the base member top surface and the lip member inner surface as shown in FIG. 4. This second angle will preferably be in a range selected from the group consisting of between 15° and 60°, between 15° and 45°, between 15° and 30°, between 30° and 60°, between 30° and 45°, and between 45° and 60°.

The elongate panel and the clasp mechanism(s) may be manufactured of any number of materials using any number of manufacturing techniques. Preferably, the elongate panel and/or the clasp mechanism(s) will comprise a plastic material selected from the group consisting of acrylonitrile butadiene styrene (ABS), polyethylene (PE), nylon, and the like. In certain embodiments, the plastic material may include fibers such as glass fibers or carbon fibers. When the elongate panel and/or the clasp mechanism(s) are manufactured of a plastic material, the preferred manufacturing method is injection molding. The clasp mechanism(s) may be integrally connected to the elongate panel—such as during the injection molding process—or may be connected to the elongate panel by way of an adhesive and/or a fastener such as a screw, a rivet, a clip, a clamp, or the like.

FIG. 5 shows an exploded view of one embodiment of a trim accent member overlay (100) with a vehicle (10) to which the trim accent member overlay may be attached with FIG. 6 showing an assembled view thereof. In the embodiment shown in FIG. 5, the trim accent member overlay is a tailgate trim member (120) which may be attached to an existing tailgate trim member (12) on a tailgate of a truck or sport utility vehicle (SUV) to repair or otherwise alter the appearance of the existing tailgate trim member. The tailgate trim member may include a single-piece tailgate trim member comprising a single elongate panel ((200) as shown in FIG. 2) or may include a multi-piece tailgate trim member comprising an elongate panel (200) and one or more secondary elongate panel(s) ((500) as shown in FIG. 8).

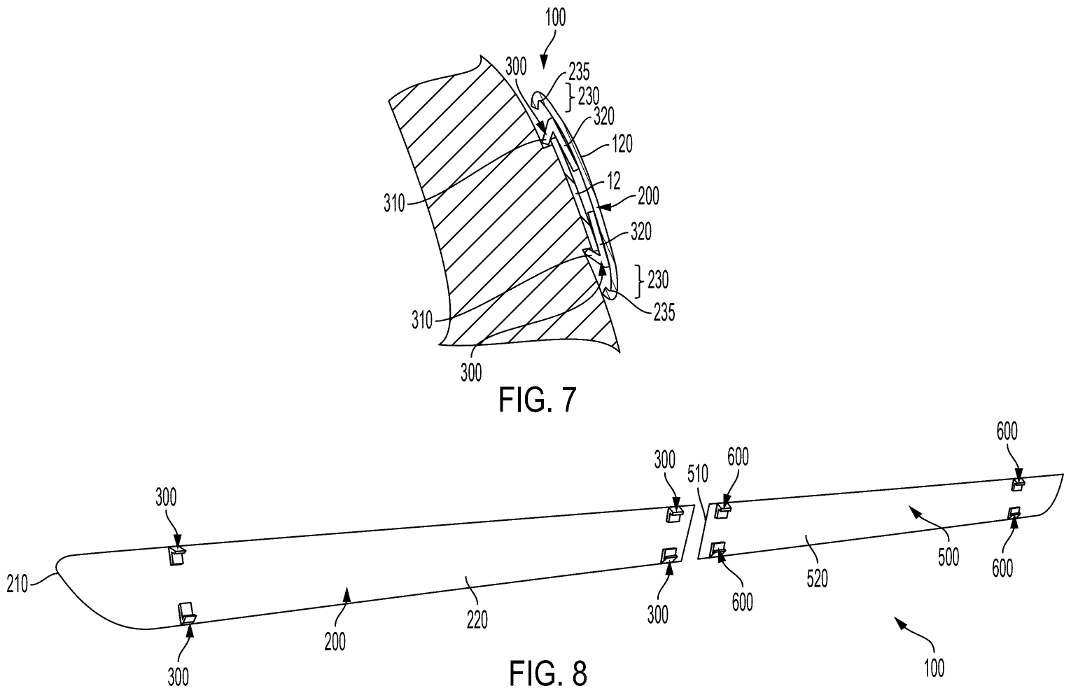

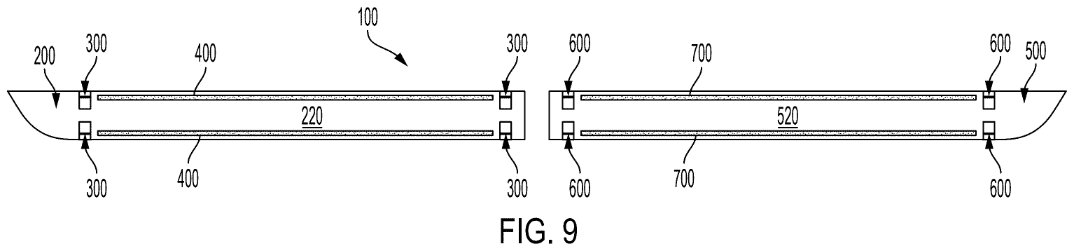

FIG. 7 shows a cut-away view of the tailgate trim member (120) overlay from FIG. 5 and FIG. 6 attached to an existing tailgate trim member (12). As shown in FIG. 7, when attached, at least a portion of the lip member inner surface (311) of each clasp mechanism (300) of the plurality of clasp mechanisms located about the perimeter of the tailgate trim member overlay engages with an inner surface of the existing tailgate trim member. The tailgate trim member is thus configured to attach to the existing tailgate trim member by first aligning the plurality of clasp mechanisms about the perimeter of the existing tailgate trim member. The installer then applies a force—often by hand—at the elongate panel top surface (210) in the direction of the existing tailgate trim member. In doing so, the lip members (310) of the plurality of clasp mechanisms, the edges of the elongate panel, or both flex outwardly away from a central axis of the elongate panel until the lip member inner surface passes the inner surface of the existing tailgate trim member, after which the lip members return to substantially their original position. Doing so snaps the tailgate trim member into place with the plurality of clasp mechanisms—and optionally the plurality of secondary clasp mechanisms in embodiments where the tailgate trim member includes one or more secondary elongate panel(s)—holding the tailgate trim member securely to the existing tailgate trim member. In some embodiments, one or more adhesive members ((400) as shown in FIG. 2)—and optionally one or more secondary adhesive members ((700) as shown in FIG. 9)—may assist in securely holding the tailgate trim member overlay to the existing tailgate trim member.

Preferably, the tailgate trim member (120) overlay will be configured with the extended surround to envelope and conceal the existing tailgate trim member (12) and ensure that the entirety of the outer surface area of the existing tailgate trim member is covered when the tailgate trim member overlay is attached to the existing tailgate trim member such that no portion of the existing tailgate trim member is visible when the tailgate trim member overlay is attached to the existing tailgate trim member. Doing so may be achieved by manufacturing the tailgate trim member overlay having perimeter dimensions which are greater in all respects when compared to the perimeter dimensions of the existing tailgate trim member. However, embodiments may exist where a small portion of the existing tailgate trim member is visible when the tailgate trim member overlay is attached to the existing tailgate trim member. The amount of the outer surface area of the existing tailgate trim member which is visible when the tailgate trim member overlay is attached to the existing tailgate trim member is preferably less than 5% of the total outer surface area of the existing tailgate trim member with less than 4% being more preferred, less than 3% being even more preferred, less than 2% being still more preferred, and less than 1% being most preferred.

FIG. 8 illustrates a perspective view of a trim accent member overlay (100) with surround comprising an elongate panel (200) and at least one secondary elongate panel (500). The elongate panel may be of any type described herein. The secondary elongate panel may be of similar construction to the elongate panel in that the secondary elongate panel has a secondary elongate panel perimeter defining a secondary panel top surface (510) and a secondary elongate panel bottom surface ((520) as shown in FIG. 9) opposite the secondary elongate panel top surface. The secondary elongate panel perimeter may come in a variety of different shapes and sizes, some of which are illustrated in the figures, depending upon the intended use of the trim accent member overlay. Nonlimiting examples of such shapes include a substantially square shape, a substantially rectangular shape, a substantially trapezoidal shape, a substantially parallelogram shape, a substantially triangular shape, a substantially ovular shape, and the like.

The secondary elongate panel perimeter may include a secondary elongate panel extended surround (530) which extends beyond the perimeter of an existing vehicle trim accent piece which the secondary elongate panel is configured to attach to such that—once attached—the trim accent member overlay (100) surrounds the entirety of the outer periphery of the existing vehicle trim accent piece. Preferably, no space is left between the outer periphery of the existing vehicle trim accent piece and the secondary elongate panel perimeter. However, in some embodiments, a small amount of space—preferably less than 2.5 mm in width, with less than 1.0 mm in width being more preferred, and less than 0.5 mm in width being still more preferred—may be left between the outer periphery of the existing vehicle trim accent piece and the secondary elongate panel perimeter when the trim accent member overlay is attached to the existing vehicle trim accent piece. In some embodiments, the secondary extended surround may include a secondary lip (535) on the secondary elongate panel perimeter which wraps around the peripheral edge of the existing vehicle trim accent piece.

FIG. 9 illustrates a bottom view of an embodiment of a trim accent member overlay (100) shown in FIG. 8. As shown in FIG. 9, when the trim accent member overlay includes a secondary elongate panel (500), the trim accent member overlay will also include a plurality of secondary clasp mechanisms (600). Each secondary clasp mechanism of the plurality of secondary clasp mechanisms may be located at a separate location about the secondary elongate panel perimeter. These secondary clasp mechanisms allow the secondary elongate panel of the trim accent member overlay to attach to a vehicle ((10), an example of which is shown in FIG. 12) about a vehicle surface such as an existing trim accent piece.

While the Figures illustrate examples of individual, narrow secondary clasp mechanism (600) which are arranged at different positions on the secondary elongate panel bottom surface (520), other embodiments may exist. In some embodiments, one or more peripheral edges of the secondary elongate panel may include a secondary clasp mechanism which extends all or a portion of the length of said peripheral edge. Certain embodiments may also exist in which each peripheral edge of the secondary elongate panel includes a secondary clasp mechanism which spans the entire length of said peripheral edges.

FIG. 9 also shows an optional secondary adhesive member (700). When present, the secondary adhesive member may be attached to the secondary elongate panel bottom surface (520) and may serve to assist—in conjunction with the secondary clasp mechanisms—in securing the secondary elongate panel to a vehicle surface. Nonlimiting examples of adhesives which may be utilized include double sided tape, glue, epoxy, and the like.

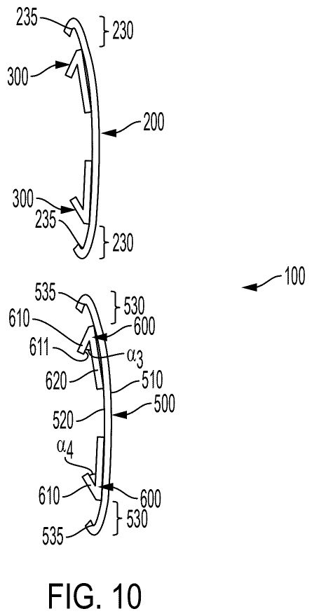

FIG. 10 illustrates an end view of an embodiment of a secondary elongate panel (500) of a trim accent member overlay (100) including additional details of a secondary clasp mechanism (600). As shown in FIG. 10, each secondary clasp mechanism of the plurality of secondary clasp mechanisms is attached to and extends from the secondary elongate panel bottom surface (520). Each secondary clasp mechanism of the plurality of secondary clasp mechanisms includes a lip member (610) and—optionally—a base member (620).

The secondary clasp mechanisms (600) may be of similar construction to the clasp mechanisms illustrated in FIG. 4 with reference to the elongate panel (200). That is to say that the secondary lip member (610) is attached to and extends from the secondary elongate panel bottom surface (520). In doing so, a third angle (α₃) is formed between the secondary elongate panel bottom surface and a secondary lip member inner surface (621). This third angle will preferably be in a range selected from the group consisting of between 15° and 60°, between 15° and 45°, between 15° and 30°, between 30° and 60°, between 30° and 45°, and between 45° and 60°. In embodiments where the elongate panel bottom surface is substantially planar, the third angle is measured between the lip member inner surface and the elongate panel bottom surface. However, embodiments may exist in which the elongate panel bottom surface is concave, convex, or otherwise includes a non-planar surface. In such instances, the third angle is measured between the lip member inner surface and a plane aligned with a central axis of the non-planar surface.

Like the clasp mechanism (300) of the elongate panel (200) illustrated in FIG. 4, the secondary clasp mechanism (600) of the secondary elongate panel (500) may include an optional secondary base member (620). When the secondary base member is present, the secondary base member includes a secondary base member perimeter defining a secondary base member top surface (621) and a secondary base member bottom surface (622) opposite the secondary base member top surface. In such cases, the secondary lip member (610) is attached to and extends from the secondary base member top surface (621). In doing so, a fourth angle (α₄) is formed between the secondary base member top surface and the secondary lip member inner surface. This fourth angle will preferably be in a range selected from the group consisting of between 15° and 60°, between 15° and 45°, between 15° and 30°, between 30° and 60°, between 30° and 45°, and between 45° and 600.

The secondary elongate panel and the secondary clasp mechanism(s) may be manufactured of any number of materials using any number of manufacturing techniques. Preferably, the secondary elongate panel and/or the secondary clasp mechanism(s) will comprise a plastic material selected from the group consisting of acrylonitrile butadiene styrene (ABS), polyethylene (PE), nylon, and the like. In certain embodiments, the plastic material may include fibers such as glass fibers or carbon fibers. When the secondary elongate panel and/or the secondary clasp mechanism(s) are manufactured of a plastic material, the preferred manufacturing method is injection molding. The secondary clasp mechanism(s) may be integrally connected to the secondary elongate panel—such as during the injection molding process—or may be connected to the secondary elongate panel by way of an adhesive and/or a fastener such as a screw, a rivet, a clip, a clamp, or the like.

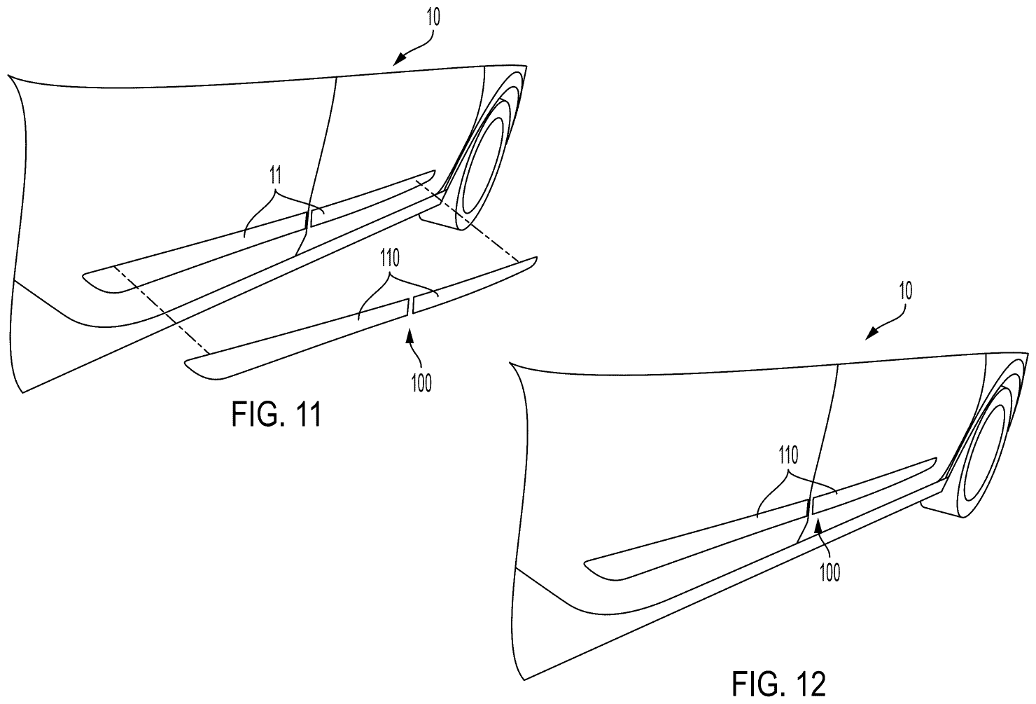

FIG. 11 shows an exploded view of one embodiment of a trim accent member overlay with a vehicle (10) to which the trim accent member overlay may be attached with FIG. 12 showing an assembled view thereof. In the embodiment shown in FIG. 11, the trim accent member overlay is a door molding (110) which may be attached to an existing door molding (11) on a door of a car, truck, sport utility vehicle (SUV), or similar vehicle to repair or otherwise alter the appearance of the existing door molding. The door molding may include a single-piece door molding comprising a single elongate panel ((200) as shown in FIG. 1) or may include a multi-piece door molding comprising an elongate panel (200) and one or more secondary elongate panel(s) ((500) as shown in FIG. 8).

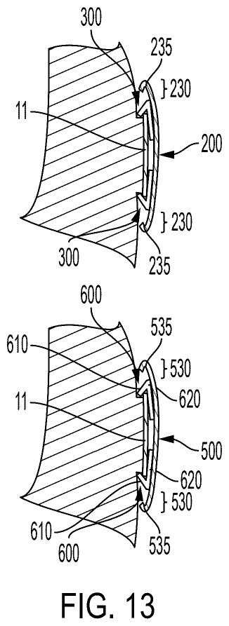

FIG. 13 shows a cut-away view of a secondary elongate panel (500) of the door molding (110) from FIG. 11 and FIG. 12 attached to an existing door molding (11). As shown in FIG. 13, when attached, at least a portion of the secondary lip member inner surface ((611) as shown in FIG. 10) of each secondary clasp mechanism (600) of the plurality of secondary clasp mechanisms located about the perimeter of the secondary panel of the door molding engages with an inner surface of the existing door molding. The door molding is thus configured to attached to the existing door molding by first aligning the plurality of clasp mechanisms about the perimeter of the existing door molding. The installer then applies a force—often by hand—at the secondary elongate panel top surface (510) in the direction of the existing door molding. In doing so, the secondary lip members (610) of the plurality of secondary clasp mechanisms flex outwardly away from a central axis of the secondary elongate panel until the secondary lip member inner surface passes the inner surface of the existing door molding, after which the secondary lip members return to substantially their original position. Doing so snaps the secondary elongate panel of the door molding into place with the plurality of secondary clasp mechanisms holding the door molding securely to the existing door molding. In some embodiments, one or more secondary adhesive members ((700) as shown in FIG. 9) may assist in securely holding the secondary elongate panel of the door molding to the existing door molding.

Preferably, the door molding (110) overlay with surround will be configured to ensure that the entirety of the outer surface area of the existing door molding (11) is covered when the door molding overlay is attached to the existing door molding such that no portion of the existing door molding is visible when the door molding overlay is attached to the existing door molding. Doing so may be achieved by manufacturing the door molding overlay with surround having perimeter dimensions which are greater in all respects when compared to the perimeter dimensions of the existing door molding. However, embodiments may exist where a small portion of the existing door molding is visible when the door molding overlay is attached to the existing door molding. The amount of the outer surface area of the existing door molding which is visible when the door molding overlay is attached to the existing door molding is preferably less than 5% of the total outer surface area of the existing door molding with less than 4% being more preferred, less than 3% being even more preferred, less than 2% being still more preferred, and less than 1% being most preferred.

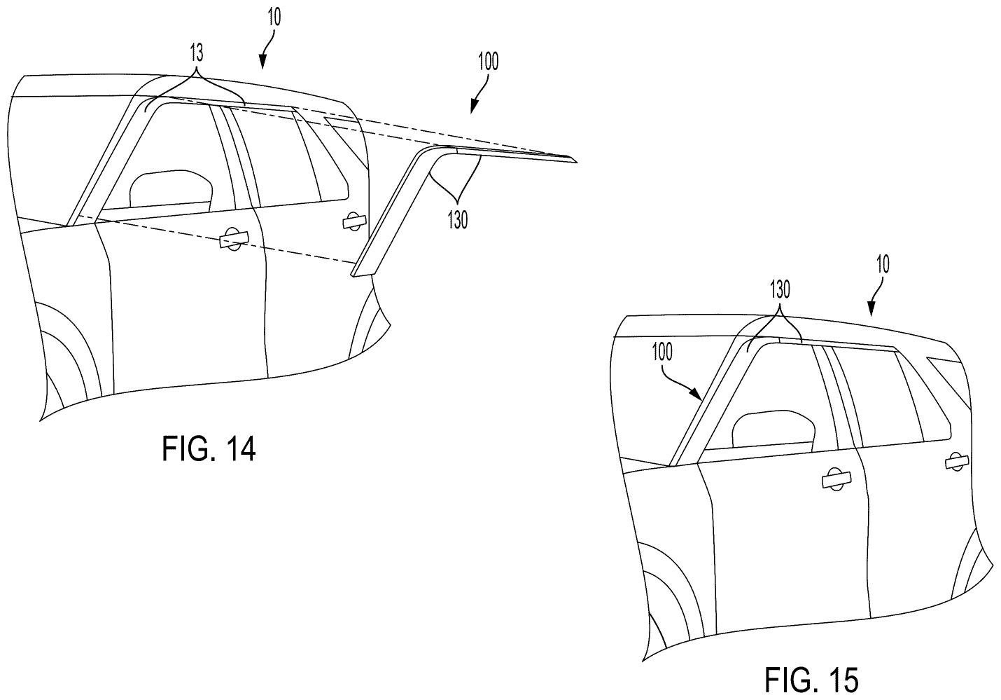

FIG. 14 shows an exploded view of one embodiment of a trim accent member overlay with a vehicle (10) to which the trim accent member overlay may be attached with FIG. 15 showing an assembled view thereof. In the embodiment shown in FIG. 14, the trim accent member overlay is a window sill molding (130) overlay with surround which may be attached to an existing window sill (13) on a window of a car, truck, sport utility vehicle (SUV), or similar vehicle to alter the appearance of the existing window area. The window sill molding overlay may include a single-piece window sill molding comprising a single elongate panel ((200) as shown in FIG. 2) or may include a multi-piece window sill molding overlay comprising an elongate panel (200) and one or more secondary elongate panel(s) ((500) as shown in FIG. 8).

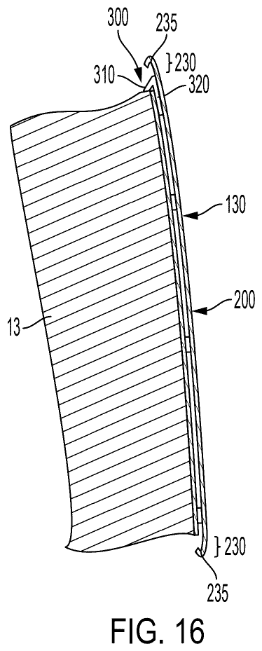

FIG. 16 shows a cut-away view of the window sill molding (130) overlay with surround from FIG. 14 and FIG. 15 attached to an existing window sill (13). As shown in FIG. 16, when attached, at least a portion of the lip member inner surface ((311) as shown in FIG. 3A) of each clasp mechanism (300) of the plurality of clasp mechanisms located about the perimeter of the window sill molding overlay engages with an inner surface of the existing window sill. The window sill molding overlay is thus configured to attached to the existing window sill by first aligning the plurality of clasp mechanisms about the perimeter of the existing window sill. The installer then applies a force—often by hand—at the elongate panel top surface (210) in the direction of the existing window sill. In doing so, the lip members (310) of the plurality of clasp mechanisms flex outwardly away from a central axis of the elongate panel until the lip member inner surface passes the inner surface of the existing window sill, after which the lip members return to substantially their original position. Doing so snaps the window sill molding into place with the plurality of clasp mechanisms—and optionally the plurality of secondary clasp mechanisms in embodiments where the window sill molding includes one or more secondary elongate panel(s)—holding the window sill molding securely to—and preferably flush with—the existing window sill. In some embodiments, one or more adhesive members ((400) as shown in FIG. 2)—and optionally one or more secondary adhesive members ((700) as shown in FIG. 9)—may assist in securely holding the window sill molding to the existing window sill.

Preferably, the window sill molding (130) overlay with surround will be configured to ensure that the entirety of the outer surface area of the existing window sill (13) is covered when the window sill molding overlay is attached to the existing window sill such that no portion of the existing window sill is visible when the window sill molding overlay is attached to the existing window sill. This may be achieved by manufacturing the window sill molding overlay with perimeter dimensions which are greater in all respects when compared to the perimeter dimensions of the existing window sill. However, embodiments may exist where a small portion of the existing window sill is visible when the window sill molding overlay is attached to the existing Window sill. The amount of the outer surface area of the existing window sill which is visible when the window sill molding overlay is attached to the existing window sill is preferably less than 5% of the total outer surface area of the existing window sill with less than 4% being more preferred, less than 3% being even more preferred, less than 2% being still more preferred, and less than 1% being most preferred.

FIG. 17 shows an exploded view of one embodiment of a trim accent member overlay with a vehicle (10) to which the trim accent member overlay may be attached with FIG. 18 showing an assembled view thereof. In the embodiment shown in FIG. 17, the trim accent member overlay is a side mirror cover (140) overlay with surround which may be attached to an existing side mirror (14) on a car, truck, sport utility vehicle (SUV), or similar vehicle to repair or otherwise alter the appearance of the existing side mirror. The side mirror cover overlay may include a single-piece side mirror cover comprising a single elongate panel ((200) as shown in FIG. 2) or may include a multi-piece side mirror cover overlay comprising an elongate panel (200) and one or more secondary elongate panel(s) ((500) as shown in FIG. 8).

FIG. 19 shows a cut-away view of the side mirror cover (140) overlay with surround from FIG. 17 and FIG. 18 attached to an existing side mirror (14). As shown in FIG. 19, when attached, at least a portion of the lip member inner surface ((311) as shown in FIG. 3A) of each clasp mechanism (300) of the plurality of clasp mechanisms located about the perimeter of the side mirror cover engages with an inner surface of the existing side mirror. The side mirror cover is thus configured to attach to the existing side mirror by first aligning the plurality of clasp mechanisms about the perimeter of the existing side mirror. The installer then applies a force—often by hand—to the elongate panel top surface (210) in the direction of the existing side mirror. In doing so, the lip members (310) of the plurality of clasp mechanisms flex outwardly away from a central axis of the elongate panel until the lip member inner surface passes the inner surface of the existing side mirror, after which the lip members return to substantially their original position. Doing so snaps the side mirror cover into place with the plurality of clasp mechanisms—and optionally the plurality of secondary clasp mechanisms in embodiments where the side mirror cover includes one or more secondary elongate panel(s)—holding the side mirror cover securely to the existing side mirror. In some embodiments, one or more adhesive members ((400) as shown in FIG. 2)—and optionally one or more secondary adhesive members ((700) as shown in FIG. 9)—may assist in securely holding the side mirror cover to the existing side mirror.

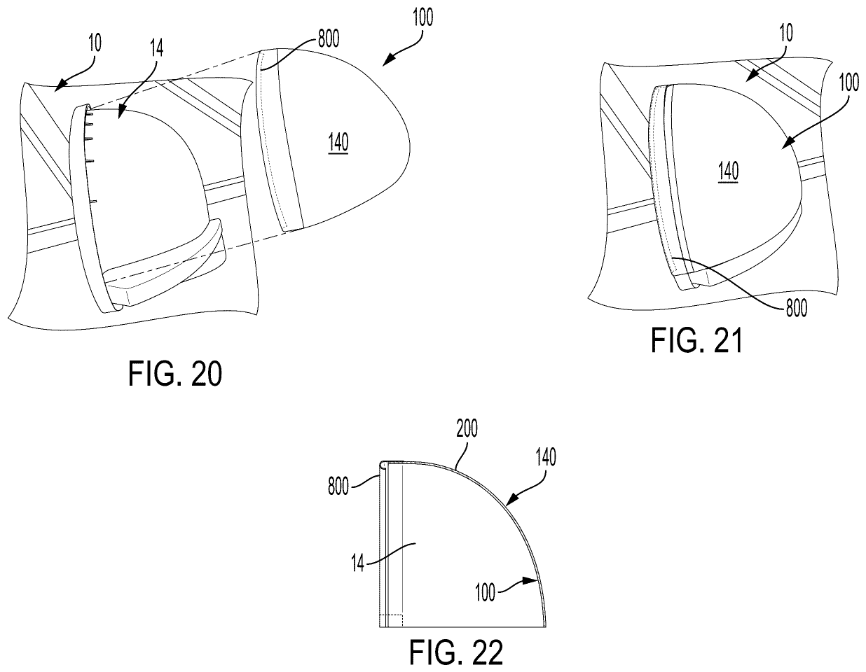

FIG. 20 shows an exploded view of an alternative embodiment of a side mirror cover (140) overlay with surround with FIG. 21 showing an assembled view thereof. In the embodiment shown in FIG. 20, at least a portion of the clasp mechanisms along the top edge of the side mirror cover have been replaced by and/or supplemented with a hook member (800). Preferably, the hook member will span the entire length of the top edge of the side mirror cover and surround the top edge of the existing side mirror (14) as shown in FIG. 20 and FIG. 21.

FIG. 22 shows a cut-away view of the side mirror cover (140) overlay with surround from FIG. 20 and FIG. 21 attached to an existing side mirror (14). As shown in FIG. 22, when attached, at least a portion of the hook member (800) along the top edge of the side mirror cover overlay engages with the top edge of the existing side mirror. The side mirror cover overlay is thus configured to attach to the existing side mirror by first aligning a portion of the hook member about a corresponding portion of the top edge of the existing side mirror. The installer then rotates the side mirror cover—often by hand—in the direction of the ground surface below the car. In doing so, the remainder of the hook member flexes outwardly around the remaining portion of the top edge of the existing side mirror allowing the side mirror cover to snap into place about the existing side mirror. In some embodiments, one or more adhesive member ((400) as shown in FIG. 2)—and optionally one or more secondary adhesive member ((700) as shown in FIG. 9)—may assist in securely holding the side mirror cover to the existing side mirror.

Preferably, the side mirror cover (140) overlay will be configured to ensure that the entirety of the outer surface area of the existing side mirror (14) is covered when the side mirror cover is attached to the existing side mirror such that no portion of the existing side mirror is visible when the side mirror cover overlay is attached to the existing side mirror. Doing so may be achieved by manufacturing the side mirror cover overlay having perimeter dimensions which are greater in all respects when compared to the perimeter dimensions of the existing side mirror. However, embodiments may exist where a small portion of the existing side mirror is visible when the side mirror cover overlay is attached to the existing side mirror. The amount of the outer surface area of the existing side mirror which is visible when the side mirror cover overlay is attached to the existing side mirror is preferably less than 5% of the total outer surface area of the existing side mirror with less than 4% being more preferred, less than 3% being even more preferred, less than 2% being still more preferred, and less than 1% being most preferred.

Another embodiment of a trim accent member overlay may be in the form of a badge overlay. Many vehicles include one or more manufacturer's badges ((15) as shown in FIGS. 5 and 6) which may be located on the vehicle's grill, hood, trunk cover, tailgate, one or more of the vehicle's door(s) and combinations thereof and indicate to consumers the make and/or model of vehicle. A badge overlay with extended surround may be attached to an existing manufacturer's badge on a car, truck, sport utility vehicle (SUV), or similar vehicle to repair or otherwise alter the appearance of the existing manufacturer's badge. The badge overlay may include a single-piece badge overlay comprising a single elongate panel ((200) as shown in FIG. 2) or may include a multi-piece badge overlay comprising an elongate panel and one or more secondary elongate panel(s) ((500) as shown in FIG. 8). In some embodiments, the elongate panel and/or the secondary elongate panel(s) may include a manufacturer's logo engraved, embossed, or printed onto the elongate panel top surface ((210) as shown in FIG. 3) or the secondary elongate panel top surface ((510) as shown in FIG. 8) respectively.

When attached to an existing manufacturer's badge, at least a portion of the lip member inner surface ((311) as shown in FIG. 3A) of each clasp mechanism ((300) as shown in FIG. 3A) of the badge overlay engages with an inner surface of the existing manufacturer's badge. The badge overlay is thus configured to attach to the existing manufacturer's badge by first aligning the plurality of clasp mechanisms about the perimeter of the existing manufacturer's badge. The installer then applies a force—often by hand—to the elongate panel top surface ((210) as shown in FIG. 3A) in the direction of the existing manufacturer's badge. In doing so, the lip members ((310) as shown in FIG. 3A) of the plurality of clasp mechanisms flex outwardly away from a central axis of the elongate panel until the lip member inner surface passes the inner surface of the existing manufacturer's badge, after which the lip members return to substantially their original position. Doing so snaps the badge overlay into place with the plurality of clasp mechanisms—and optionally the plurality of secondary clasp mechanisms in embodiments where the badge overlay includes one or more secondary elongate panel(s)—holding the badge overlay securely to the existing manufacturer's badge. In some embodiments, one or more adhesive members ((400) as shown in FIG. 2)—and optionally one or more secondary adhesive members ((700) as shown in FIG. 9)—may assist in securely holding the badge overlay to the existing manufacturer's badge.

The disclosed embodiments of a trim accent member overlay with integrated clasp mechanisms may be precisely and securely install on a vehicle by simply aligning the elongate panel/secondary elongate panel and applying pressure—often by hand—at the outer surface thereof until said panel snaps into place. Doing so eliminates the installation issues associated with the use of prior art clips and adhesives. The secure connection created by the integrated clasp mechanisms also improves safety of vehicle operation by reducing or eliminating the likelihood of the trim accent member overlay becoming separated from the vehicle or otherwise damaged during vehicle operation. In addition, the presence of the extended surround reduces or eliminates the amount of the original vehicle trim member which is visible about the perimeter of the trim accent member overlay thereby improving the aesthetic appearance of the vehicle.

While the trim accent member overlays have been described as having one or more exemplary designs, the present trim accent member overlays may be further modified within the spirit and scope of this disclosure. This application is therefore intended to cover any variations, uses, or adaptations of the trim accent member overlays disclosed herein using their general principles.

What is claimed is:

1. A trim accent member overlay (100) for covering and surrounding an existing vehicle trim accent piece of a vehicle (10), said trim accent member overlay comprising:
an elongate panel (200) having an elongate panel perimeter defining an elongate panel top surface (210) and an elongate panel bottom surface (220) opposite the elongate panel top surface;
an extended surround (230) attached to and extending from the elongate panel perimeter; and
a plurality of clasp mechanisms (300) attached to and extending from the elongate panel bottom surface, each clasp mechanism of the plurality of clasp mechanisms having a lip member (310) having a lip member inner surface (311), said lip member being attached to and extending from the elongate panel bottom surface; and
wherein each clasp mechanism of the plurality of clasp mechanisms is attached to the elongate panel bottom surface, and a first angle (α₁) formed between the elongate panel bottom surface and the lip member inner surface of each clasp mechanism of the plurality of clasp mechanisms is in a range of between 15° and 60°.

2. The trim accent member overlay of claim 1, wherein at least one clasp mechanism of the plurality of clasp mechanisms includes a base member (320) having a base member perimeter defining a base member top surface (321) and a base member bottom surface (322) opposite the base member top surface, the base member bottom surface is attached to the elongate panel bottom surface, and a second angle (α₂) formed between the base member top surface and the lip member inner surface of each clasp mechanism of the plurality of clasp mechanisms is in a range of between 15° and 60°.

3. The trim accent member overlay of claim 1, wherein each clasp mechanism of the plurality of clasp mechanisms includes a base member (320) having a base member perimeter defining a base member top surface (321) and a base member bottom surface (322) opposite the base member top surface, the base member bottom surface is attached to the elongate panel bottom surface, and a second angle (α_{z}) formed between the base member top surface and the lip member inner surface of each clasp mechanism of the plurality of clasp mechanisms is in a range of between 15° and 60°.

4. The trim accent member overlay of claim 1, wherein each clasp mechanism of the plurality of clasp mechanisms is located at a separate location about the elongate panel perimeter.

5. The trim accent member overlay of claim 1, further comprising at least one adhesive member (400) attached to the elongate panel bottom surface.

6. The trim accent member overlay of claim 1, wherein the elongate panel comprises a material selected from the group consisting of acrylonitrile butadiene styrene (ABS), polyethylene (PE), and nylon.

7. The trim accent member overlay of claim 1, wherein the extended surround is configured to cover the existing vehicle trim accent piece such that less than 5% of a total surface area of the existing trim accent piece is visible when the trim accent member overlay is attached to the existing vehicle trim accent piece.

8. The trim accent member overlay of claim 1, further comprising:
at least one secondary elongate panel (500) having a secondary elongate panel perimeter defining a secondary elongate panel top surface (510) and a secondary elongate panel bottom surface (520) opposite the secondary elongate panel top surface;
a secondary elongate panel extended surround (530) attached to and extending from the secondary elongate panel perimeter; and
a plurality of secondary clasp mechanisms (600) attached to and extending from the secondary elongate panel bottom surface, each secondary clasp mechanism of the plurality of secondary clasp mechanisms having a secondary lip member (610) having a secondary lip member inner surface (611), said secondary lip member being attached to and extending from the secondary elongate panel bottom surface; and
wherein each secondary clasp mechanism of the plurality of secondary clasp mechanisms is attached to the secondary elongate panel bottom surface, and a third angle (α₃) formed between the secondary elongate panel bottom surface and the secondary lip member inner surface of each clasp mechanism of the plurality of secondary clasp mechanisms is in a range of between 15° and 60°.

9. The trim accent member overlay of claim 8, wherein at least one secondary clasp mechanism of the plurality of clasp mechanisms includes a secondary base member (620) having a secondary base member perimeter defining a secondary base member top surface (621) and a secondary base member bottom surface (622) opposite the secondary base member top surface, the secondary base member bottom surface is attached to the secondary elongate panel bottom surface, and a fourth angle (α₄) formed between the secondary base member top surface and the secondary lip member inner surface of each secondary clasp mechanism of the plurality of secondary clasp mechanisms is in a range of between 15° and 60°.

10. The trim accent member overlay of claim 8, wherein each secondary clasp mechanism of the plurality of clasp mechanisms includes a secondary base member (620) having a secondary base member perimeter defining a secondary base member top surface (621) and a secondary base member bottom surface (622) opposite the secondary base member top surface, the secondary base member bottom surface is attached to the secondary elongate panel bottom surface, and a fourth angle (α₄) formed between the secondary base member top surface and the secondary lip member inner surface of each secondary clasp mechanism of the plurality of secondary clasp mechanisms is in a range of between 15° and 60°.

11. The trim accent member overlay of claim 8, wherein each secondary clasp mechanism of the plurality of secondary clasp mechanisms is located at a separate location about the secondary elongate panel perimeter.

12. The trim accent member overlay of claim 8, further comprising at least one secondary adhesive member (700) attached to the secondary elongate panel bottom surface.

13. The trim accent member overlay of claim 8, wherein the secondary elongate panel comprises a material selected from the group consisting of acrylonitrile butadiene styrene (ABS), polyethylene (PE), and nylon.

14. The trim accent member overlay of claim 8, wherein the secondary elongate panel extended surround is configured to cover a secondary existing vehicle trim accent piece such that less than 5% of a total surface area of the secondary existing trim accent piece is visible when the secondary elongate panel is attached to the secondary existing vehicle trim accent piece.

15. The trim accent member overlay of claim 1, wherein the trim accent member overlay is in the form of a door molding (110) configured to attach to an existing door molding (11) of the vehicle by engaging the plurality of clasp mechanisms to the existing door molding.

16. The trim accent member overlay of claim 1, wherein the trim accent member overlay is in the form of a tailgate trim member (120) configured to attach to an existing tailgate trim member (12) of the vehicle by engaging the plurality of clasp mechanisms to the existing tailgate trim member.

17. The trim accent member overlay of claim 1, wherein the trim accent member overlay is in the form of a window-sill molding (130) configured to attach to an existing window sill (13) of the vehicle by engaging the plurality of clasp mechanisms to the existing window sill.

18. The trim accent member overlay of claim 1, wherein the trim accent member overlay is in the form of a side mirror cover (140) configured to attach to an existing side mirror (14) of the vehicle by engaging the plurality of clasp mechanisms to the existing side mirror.

19. The trim accent member overlay of claim 1, wherein the trim accent member overlay is in the form of a badge overlay configured to attach to an existing manufacturer's badge of the vehicle by engaging the plurality of clasp mechanisms to the existing manufacturer's badge.

20. A process for manufacturing a trim accent member overlay (100) for covering and surrounding an existing vehicle trim accent piece of a vehicle (10), said trim accent member overlay comprising: an elongate panel (200) having an elongate panel perimeter defining an elongate panel top surface (210) and an elongate panel bottom surface (220) opposite the elongate panel top surface; and a plurality of clasp mechanisms (300) attached to and extending from the elongate panel bottom surface, each clasp mechanism of the plurality of clasp mechanisms having a lip member (310) having a lip member inner surface (311), said lip member being attached to and extending from the elongate panel bottom surface; and wherein each clasp mechanism of the plurality of clasp mechanisms is attached to the elongate panel bottom surface, and a first angle (α₁) formed between the elongate panel bottom surface and the lip member inner surface of each clasp mechanism of the plurality of clasp mechanisms is in a range of between 15° and 60°, said process comprising the steps of:
providing a mold having a mold cavity in the form of the trim accent panel member overlay;
injecting a molten material selected from the group consisting of acrylonitrile butadiene styrene (ABS), polyethylene (PE), and nylon into the mold cavity;
allowing the molten material to cool and cure; and
removing the trim accent member overlay from the mold cavity.
